(19) United States
(12) Patent Application Publication
(10) Pub. No.: US 2014/0173429 A1
(43) Pub. Date: Jun. 19, 2014

(54) INFORMATION PROCESSING APPARATUS, CONTROL METHOD THERFOR, AND STORAGE MEDIUM

(71) Applicant: Canon Kabushiki Kaisha, Tokyo (JP)

(72) Inventor: Keiichi Takashima, Kawasaki-shi (JP)

(73) Assignee: Canon Kabushiki Kaisha, Tokyo (JP)

(21) Appl. No.: 14/098,828

(22) Filed: Dec. 6, 2013

(30) Foreign Application Priority Data
Dec. 14, 2012 (JP) 2012-273501

(51) Int. Cl. G06F 3/0488

(52) U.S. Cl. CPC G06F 3/0488
USPC 715/708

(57) ABSTRACT

To provide an information processing apparatus that displays help information related to a predetermined item upon receipt of an operation for a predetermined time period to the predetermined item that is displayed on the screen. When an operation is performed to an item that is different from the predetermined item after the help information related to the predetermined item is displayed, help information related to the different item is displayed on the screen without waiting for an operation for the predetermined time period to the different item.

### BACKGROUND OF THE INVENTION

1. Field of the Invention

The present disclosure relates to an information processing apparatus, a control method therefor, and a storage medium.

2. Description of the Related Art

During display of an operation screen of an editing application, a help screen including help information is displayed in response to an input for instructing to display the help information related to the operation screen.

For example, Japanese Patent Application Laid-Open No. 2007-334025 discloses an operation apparatus configured to receive a user operation such as a double click or a long press of an operation button displayed on a touch panel and to pop up help information corresponding to the operation button.

However, when the operation apparatus disclosed in Japanese Patent Application Laid-Open No. 2007-334025 is applied, a user must perform a specific operation such a long press of the panel in order to display simple help. Consequently, after the simple help is displayed for a given item, in order to display simple help in relation to another item, the user must perform a further specific operation such as a long press of another item. Therefore, there is a risk of reduction of user operability.

### SUMMARY OF THE INVENTION

The information processing apparatus of the present invention switches a display of help information related to a predetermined item that is displayed on a screen to a display of help information related to another item with a simple operation.

An information processing apparatus of one embodiment of the present invention includes a display control unit configured to display help information related to a predetermined item upon receipt of an operation for a predetermined time period to the predetermined item that is displayed on a display screen that includes a touch panel. When an operation is performed to an item that is different from the predetermined item after the help information related to the predetermined item is displayed, help information related to the different item is displayed on the screen without waiting for an operation for the predetermined time period to the different item.

Further features of the present invention will become apparent from the following description of embodiments with reference to the attached drawings.

### BRIEF DESCRIPTION OF THE DRAWINGS

FIG. 1 illustrates a block diagram of a configuration of an information processing apparatus according to an embodiment of the present invention.

FIG. 2 illustrates a block diagram of a module configuration of FIG. 1.

FIG. 3 is a flowchart for describing event processing of an application.

FIG. 4 is a flowchart for describing long press touch processing.

FIG. 5 is a flowchart for describing touch release processing.

FIG. 6 is a flowchart for describing touch position moving processing.

FIG. 7 is a flowchart for describing tap processing.

FIG. 8 illustrates an example of a data structure of a simple help information DB.

FIG. 9 illustrates an example of an application screen.

FIG. 10 is a flowchart for describing help application processing.

### BRIEF DESCRIPTION OF THE EMBODIMENTS

### First Embodiment

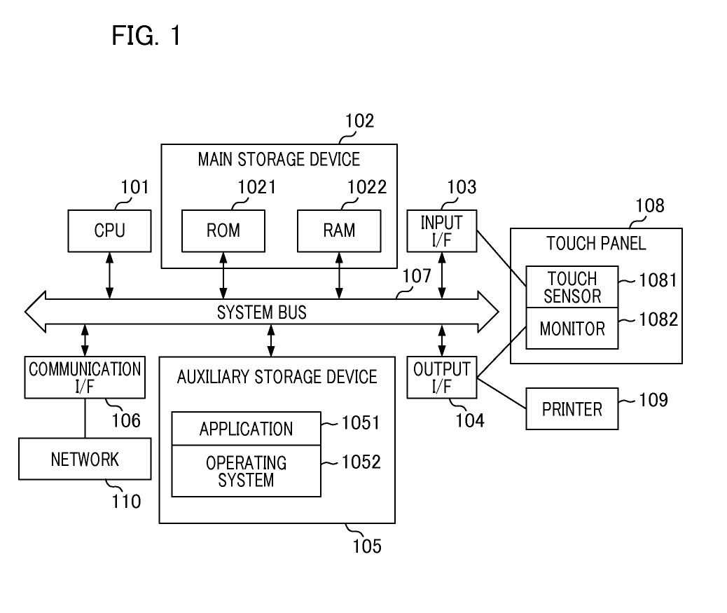

FIG. 1 illustrates a block diagram of a configuration of an information processing apparatus according to an embodiment of the present invention. A description will be given of an information processing apparatus according to this embodiment by taking Windows (Registered Trademark) of Microsoft Corporation as an example of an operating system. Needless to say, the present invention may be applied without particular limitation in relation to any device configuration as long as functions of the present invention are enabled. The system may be configured as a stand-alone unit such as a mobile terminal, image processing apparatus or the like, as a system configured from a plurality of devices, or a system configured for processing by connection through a network such as a LAN, WAN, or the like. LAN is an abbreviation for local area network, WAN is an abbreviation for wide area network.

The information processing apparatus illustrated in FIG. 1 includes a CPU 101, a main storage device 102, an input I/F (interface) 103, an output I/F 104, an auxiliary storage device 105, an communication I/F 106, a system bus 107, a touch panel 108, a printer 109, and a network 110. The main storage device 102 includes a ROM 1021 and a RAM 1022. The auxiliary storage device 105 includes an application 1051 and an operating system 1052. The touch panel 108 includes a touch sensor 1081 and a monitor 1082. The CPU 101 is an abbreviation for a central processing unit. The ROM 1021 is an abbreviation for a read only memory, and the RAM 1022 is an abbreviation for a random access memory.

The CPU 101 executes control of the overall apparatus in accordance with a program that is stored in the RAM 1022 or the ROM 2021 of the main storage device 102, or the auxiliary storage device 105. The RAM 1022 is also used as a work area when the CPU 101 executes various types of processing. The auxiliary storage device 105 stores the operating system (OS) 1052, the application 1051, or the like. The touch panel 108 is a device that integrates the touch sensor 1081 that is an input device with the monitor 1082 that is an output device. The input device such as the touch sensor 1081 is configured to convey various types of instructions from the user through the input I/F 103 to the computer. In the present embodiment, although only the touch sensor 1081 is connected to the information processing apparatus as an input device, a mouse or a keyboard may also be connected to the information processing apparatus.

The output I/F 104 is an interface for outputting data to an external unit, and outputs data to a display that has a touch panel 108, that is to say, to an output device such as the monitor 1082 or the printer 109. The information processing apparatus may be connected to the printer 109 through not only a local I/O for direct connection but through the network 110 with the communication I/F 106. The system bus 107 is a common data system bus and executes data exchange with the modules.

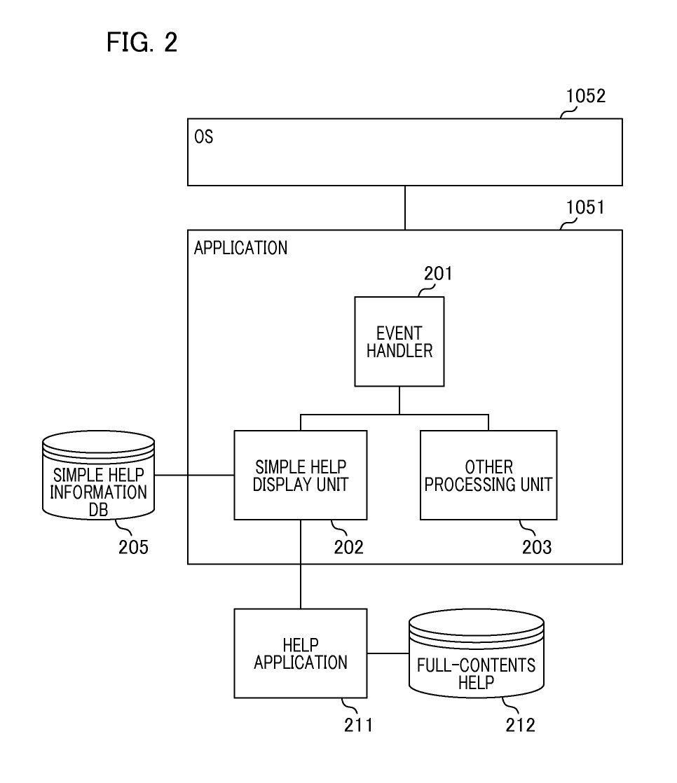

FIG. 2 illustrates a block diagram of the module configuration of the application 1051 illustrated in FIG. 1. The application 1051 includes an event handler 201, a simple help display unit 202, and an other processing unit 203. The application 1051 executes data exchange with the OS 1052, the simple help information data base (DB) 205, and a help application 211.

When a user operates the touch panel 108 illustrated in FIG. 1, the touch sensor 1081 detects input signal based on the operation. The detected input signal is sent to the OS 1052 through the input I/F 103. The OS 1052 modifies the received input signal to one of various types of events and sends the event to the application 1051. For example, the OS 1052 sends, to the application 1051 as an event, a touch initiation event when the user touches the touch panel 108 with a finger or a touch release event when the finger is removed from the touch panel 108. The OS 1052 sends a touch position moving event to the application 1051 when the user moves the position of the finger while keeping the finger in contact with the touch panel.

An event may also be sent to the application 1051 by the OS 1052 in response to composite conditions such as the touch position or the continuous time of contact. For example, when the finger is removed (tapped) within a preset time period after touching the touch panel 108 without changing the position, the OS 1052 sends a tap event to the application 1051. Furthermore, after touching the touch panel 108 and when the contact is continued for more than a preset time period without changing the position and removing the finger, the OS 1052 sends a long press touch event to the application 1051. Information such as the touch position, the continuous contact time, and the contact pressure, or the like is associated with the event related to the touch input, and such associated information may be acquired by the application 1051 upon receipt of the event. In addition to the event that is input through the input I/F 103, the event includes an event received through network communication, an event received through communication of the OS 1052 or the application 1051, or the like.

The event handler 201 receives an event from the OS 1052 and executes processing depending on the received event. The simple help display unit 202 performs event processing in relation to simple help. For example, when an event received from the OS 1052 is an event related to simple help, the event handler 201 of the simple help display unit 202 accesses the simple help information DB 205 and acquires simple help information. Then, the simple help display unit 202 displays the acquired simple help information on the monitor 1082 of the touch panel 108. The simple help information DB 205 may be provided in the application 1051 or may be stored in a separate region other than the application 1051 of the auxiliary storage device 105. Further details will be described below.

The other processing unit 203 performs event processing not related to simple help. The help application 211 is an application that is different from the application 1051, and provides a help function to a user related to operations. The help application 211 activates in response to a command from the simple help display unit 202, and displays detailed help information by using full-contents help 212. The full-contents help 212 may be located within the help application 211, may be stored in a separate region other than the auxiliary storage device 105, or may be acquired through the network 110 such as a website on the Internet.

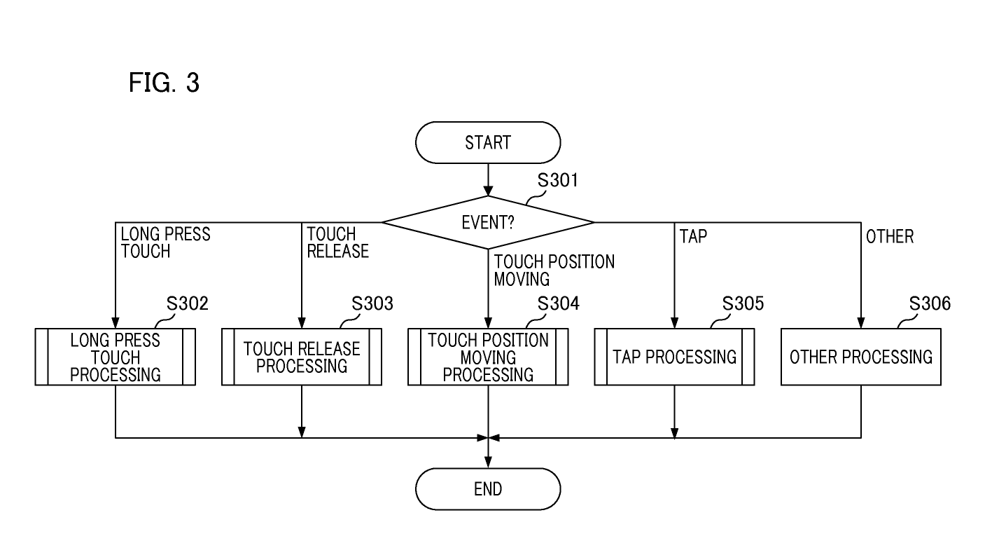

FIG. 3 is a flowchart for describing the overall processing of the application 1051. The flowchart of the present application is executed by the CPU 101 which performs processing by reading a related program from the memory. Firstly, in S301, when receiving various types of events from the OS 1052, the event handler 201 determines an event type, selects processing that corresponds to the determined event type (S302 to 306), and terminates the processing after completing the processing. The examples explained in the present embodiment include event processing for long press touch (S302), touch release (S303), touch position moving (S304), and tap (S305). The event handler 201 may executes the event processing according to a determination by the event handler 201 based on a different event. For example, processing may be performed by execution of long press touch processing 302 by determining a touch event processing on the basis of the touch position and the touch time. Since other event processing (S306) is not a necessary characteristic of the present invention, related description will be omitted.

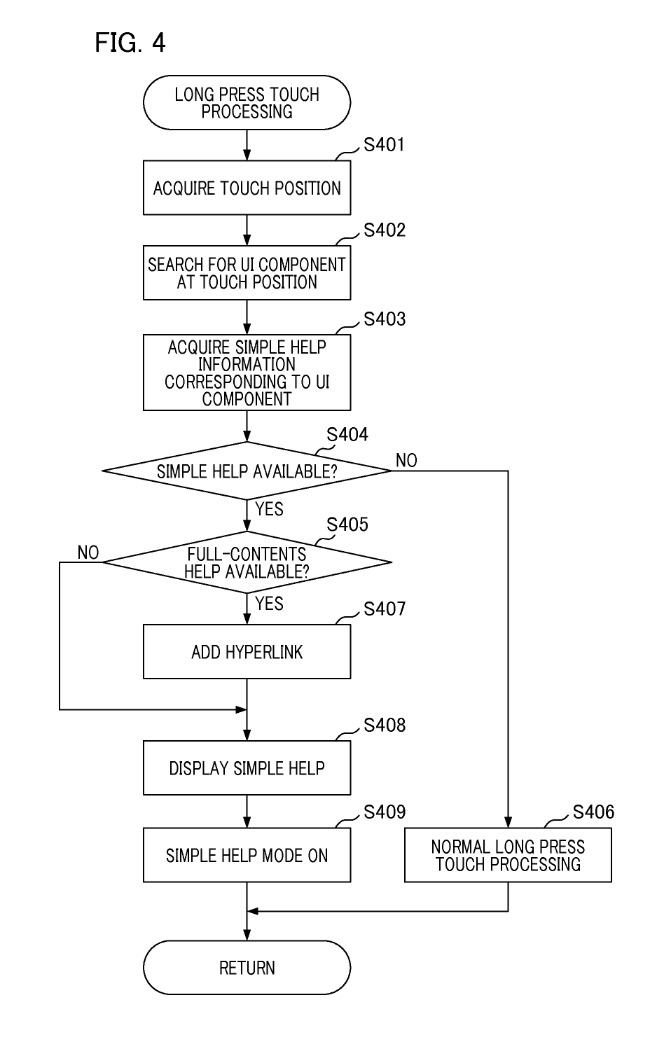

FIG. 4 is a detailed flowchart for describing the long press touch processing (S302). The long press touch is a touch operation on a predetermined item for more than a predetermined time period. Using the flowchart illustrated in FIG. 4, an explanation will be given of the processing for displaying help information and validating a help mode when the simple help display unit that functions as a display control unit receives an operation to predetermined item for more than the predetermined time period. Firstly, when the event handler 201 determines a long press touch event through the touch panel 108 by a user, the simple help display unit 202 acquires a touch position (S401). Then the simple help display unit 202 searches for a user interface (UI) component corresponding to the touch position (S402). An example of the UI component includes a predetermined item related to each print setting that are displayed on a print settings screen 900 illustrated in FIG. 9. The simple help display unit 202 acquires help information associated with the detected UI component, for example, help information associated with the UI component ID of the retrieved UI component from the simple help information DB 205 (S403).

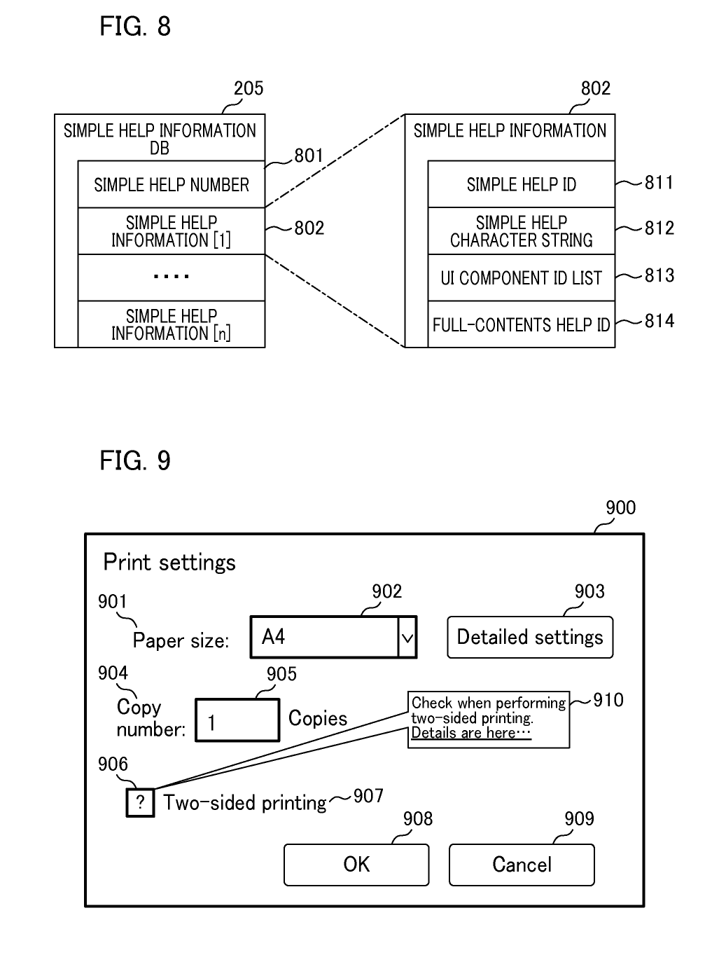

FIG. 8 illustrates an example of the data structure of the simple help information DB 205. The simple help information DB 205 is configured from a simple help number 801 and simple help information 802 for simple help numbers. The various types of simple help information 802 are configured from a simple help ID 822, a simple help character string 812, a UI component ID list 813, and a full-full-contents help ID 814, or the like. The simple help ID 811 is an identifier uniquely identifying the simple help character string 812. The simple help character string 812 is a character string displayed by the simple help display unit 202 as simple help information on the screen, and may be configured as plain text, or as a character string such as an HTML format or the like that has a character attribution such as font size. HTML is an abbreviation for hypertext markup language.

The UI component ID list 813 is a list of UI components that corresponds to the simple help character string 812, and includes at least one UI component ID. One UI component is not used across a plurality of simple help information since it is included in the UI component ID list 813 of any one of the simple help information 802 in the simple help information DB 205. That is to say, the simple help information DB 205 functions as a storage unit that stores a UI component ID by associating it with help information. The UI component may not be included in any UI component ID list 813 of the simple help information 802 for example in the case where the simple help information for display on the screen is not present.

The full-contents help ID 814 is an identifier in the full-contents help 212 for uniquely identifying the full-contents help corresponding to the simple help ID 811. When a corresponding full-contents help is not available, the full-contents help ID 814 has no value.

Next, the simple help display unit 202 determines whether the simple help information 802 in S403 can be acquired (S404), and when acquisition cannot be acquired, normal long press touch processing is performed (S406), and then processing is quitted. The simple help display unit 202 also cannot acquire simple help information 802 in S403 when a UI component for the touch position in S402 is not retrieved. When the simple help information 802 is acquired, the simple help display unit 202 determines whether the full-contents help ID 814 of the acquired simple help information 802 has a value (S405), and when the full-contents help ID 814 has no value, the processing proceeds to S408.

When the full-contents help ID 814 has no value in S405, the simple help display unit 202 adds a character string including a hyperlink in which the full-contents help ID 814 is the link destination posterior to the simple help character string 812 (S407). That is to say, a character string such as an added hyperlink or the like is access information to the help application 211. The simple help display unit 202 as described below activates the full-contents help 212 when the hyperlink is clicked. Therefore, the added character string preferably includes wording such as “Details are here . . . ” as illustrated in the simple help information 910 in FIG. 9 to thereby induce the user to activate the full-contents help 212. The simple help display unit 202 pops up the simple help character string 812 on the screen of (S408). The simple help display unit 202 sets a simple help mode that is stored in the work area of the RAM 1022 to the ON position (S409), and then quits processing. In the present embodiment, when the simple help mode is ON, it means the long press touch is in progress.

FIG. 9 illustrates an example of a screen displayed by the application 1051. This example of a screen is a print setting screen 900 on which the print conditions that are applicable when printing are set. The long press touch processing (S302) will be explained with the screen. Although UI components such as paper size 901 to Cancel 909 are located on the print setting screen 900, each UI component operation is known, and therefore explanation that is not related to the long press processing will be omitted. For example, when a long press touch is performed by a user on the two-sided printing label 907, a long press touch event occurs. When the application 1051 receives the long press touch event, the simple help display unit 202 acquires the touch position (S401). When the simple help display unit 202 retrieves a UI component in the touch position based on a UI definition file (not illustrated) in the application 1051, the UI component ID of the two-sided printing label 907 can be acquired (S402).

Then, the simple help display unit 202 accesses the simple help information DB 205 and acquires simple help information 802 in which the UI component ID list includes the UI component ID coincident with the UI component ID for the acquired two-sided printing label 907 (S403). When the full-contents help ID 814 a value of the acquired simple help information 802, the simple help display unit 202 adds, to the simple help character string 812, a character string such as “Details are here . . . ” to which a hyperlink is attached. Then the simple help display unit 202 displays the simple help 910 on the print setting screen 900.

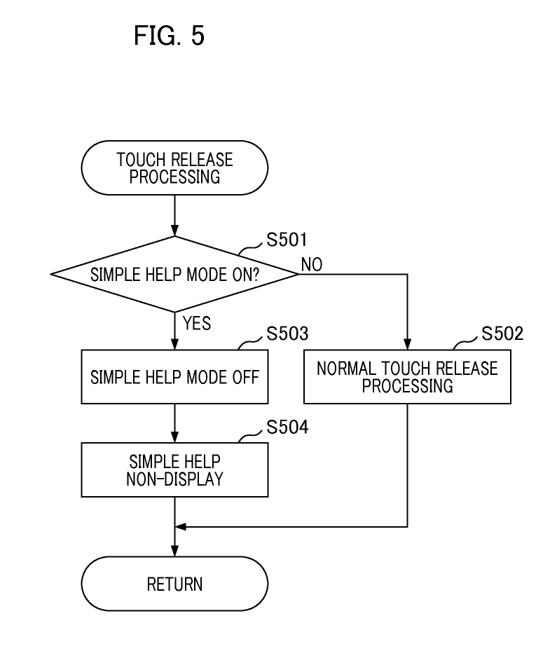

FIG. 5 is a detailed flowchart for describing the touch release processing (S303), that is, processing that is executed when the finger is removed from the touch panel. The simple help display unit 202 determines whether the simple help mode that is stored in the work area of the RAM 1022 is ON (S501), and when the mode is OFF, performs normal touch release processing (S502), and then quits processing. When the simple help mode is ON, the simple help display unit 202 sets the simple help mode that is stored in the work area of the RAM 1022 to OFF (S503), hides the simple help that is currently displayed (S504), and quits processing.

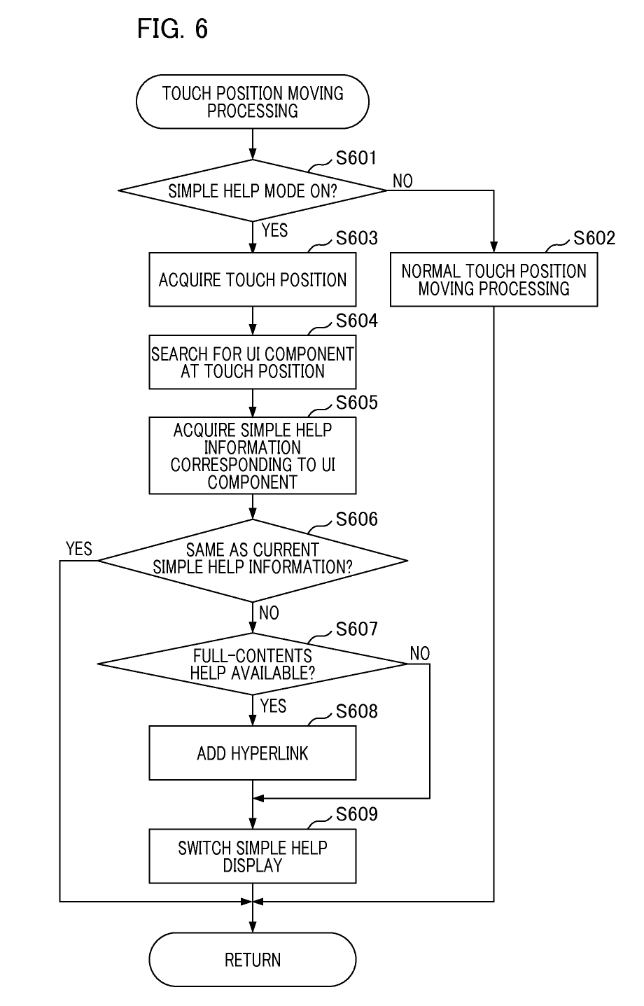

FIG. 6 is a detailed flowchart for describing the touch position moving processing (S304). Firstly, the simple help display unit 202 determines whether the simple help mode that is stored in the work area of the RAM 1022 is on the ON position (S601), and when the mode is OFF, performs normal touch release processing (S602), and then quits processing. When the simple help mode is ON, the simple help display unit 202 acquires the touch position that is changed due to the movement of the finger (S603), and searches for the UI component that corresponds to the acquired touch position by using the UI definition file of the application 1051(S604). The simple help display unit 202 acquires the simple help information corresponding to the retrieved UI component (S605). The processing performed in the step S603 is the same as that performed in S401, S604 is the same as that performed in S402, and S605 is the same as that performed in S403, and therefore detailed description will not be repeated.

Next, the simple help display unit 202 performs a comparison to determine whether or not the simple help ID 811 of the simple help information 802 acquired in S605 is the same as the simple help ID 811 of the simple help in the current display (S606), and when the information is the same, processing is quitted. When the simple help ID 811 of the simple help is different, the simple help display unit 202 determines whether the full-contents help ID 814 of the acquired simple help information 802 has a value (S607). When the full-contents help ID 814 has no value, the processing proceeds to S609. When the full-full-contents help ID 814 has a value in S607, the simple help display unit 202 adds a character string posterior to the simple help character string 812 to include the hyperlink using the full-full-contents help ID 814 as the link destination (S608). The processing performed in the step S6073 is the same as that performed in S405. Also, the processing performed in the step S6073 is the same as that performed in S407. Then the simple help display unit 202 switches the character string for the simple help in the current pop-up display to the simple help character string 812 acquired in S605 (S609). Otherwise, the simple help display unit 202 switches the character string for the simple help in the current pop-up display to the character string in which the hyperlink attached character string is added to the simple help character string 812 acquired in S605, and then quits processing.

With the above processing, the information processing apparatus according to the present invention can switch a display of help information corresponding to a predetermined item displayed on a screen to a display of help information corresponding to another item with a simple operation. That is to say, a user moves his finger a touch position while keeping the finger in contact with the screen, for example, in FIG. 9 without removing the finger from the touch panel after the user performs a long press touch operation. As described with reference to FIG. 6, the application 1051 that detects this operation displays simple help for the setting item of the destination without waiting or receiving the long press touch operation. Consequently, user operability is enhanced because simple help corresponding to the destination due to the touch movement can be continuously and rapidly switched, and displayed.

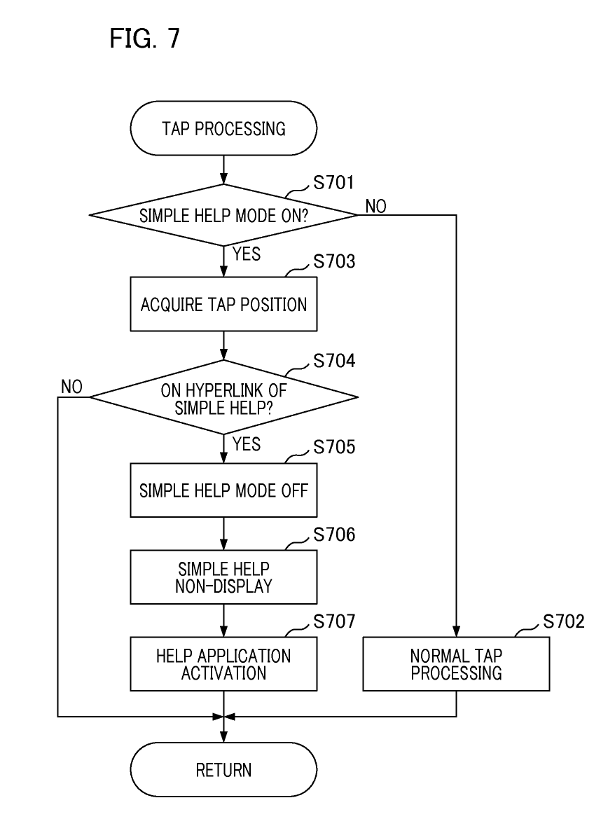

FIG. 7 is a detailed flowchart for the describing tap processing (S305). Firstly, the simple help display unit 202 determines whether the simple help mode that is stored in the work area of the RAM 1022 is ON (S701), and when the mode is OFF, performs normal touch processing (S702), and then quits processing. When the simple help mode is ON, the simple help display unit 202 acquires a tap position (S703), and determines whether the tap position is on a hyperlink of the simple help in the current pop-up display (S704). When the tap position is not on a hyperlink, the processing is quitted. When the tap position is on a hyperlink, the simple help display unit 202 sets the simple help mode stored in the work area of the RAM 1022 to OFF (S705), and hides the simple help that is currently displayed (S706). For example, YES is determined in S704 when the hyperlink in the query storing 910 in FIG. 9 is tapped with a right-hand finger in a state where a finger of a user's left hand touches the screen in FIG. 9 with a long press and. Then the simple help display unit 202 commands the OS 1052 so that the help application 211 activates the full-contents help 212 for an initial display (that is to say, displays the initial display as another screen) (S707), and then quits processing.

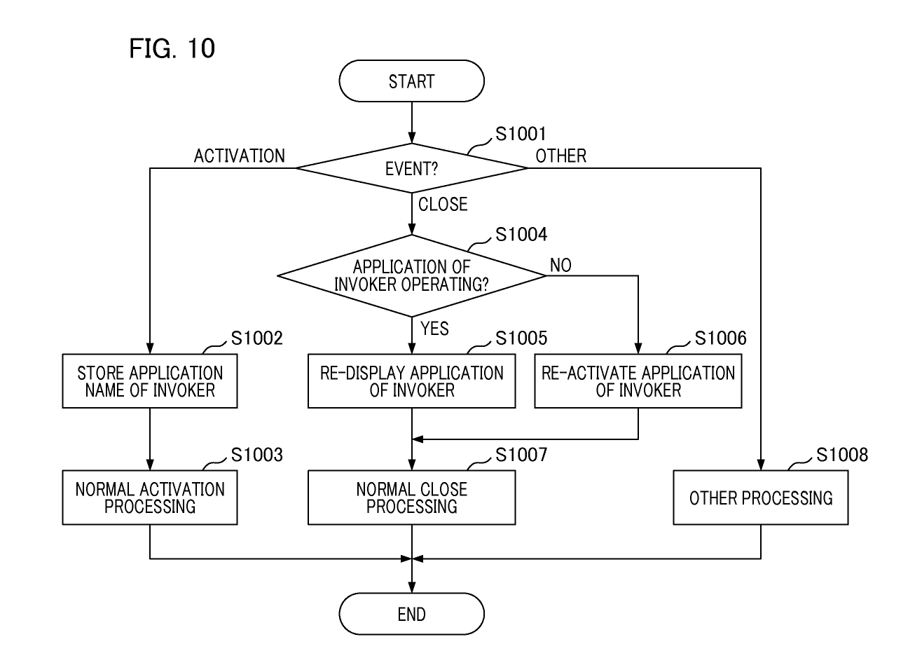

FIG. 10 is a flowchart for describing event processing of the help application 211. Firstly, the help application 211 determines an event type upon receipt of various types of event from the OS 1052 (S1001), and then executes processing in response to the event type. When the event is an activation event, normal activation processing is performed (S1003) after storing the module name of the application that is an invoker (in this case, the application 1051) in the work area of the RAM 1022. That is to say, the help application 211 functions as a detailed information display unit, displays full-contents help 212 in accordance with a command from the application 1051 through the OS 1052, and then quits processing.

When the event is a close event, the help application 212 searches to confirm whether the application (1051) that is the invoker is present in the applications currently operating (S1004). The determination of the application (1051) that is the invoker is performed by confirming whether or not the module name of the application is the same as the module name stored in the work area of the RAM 1022. When application (1051) that is the invoker is currently operating, the help application 211 re-displays the screen of the application (1051) that is the invoker (S1005). When application (1051) that is the invoker is not currently operating, the help application 211 re-activates the application (1051) that is the invoker (S1006). Thereafter, a normal close processing, that is to say, a display termination for the full-contents help 212 is performed (S1007), and processing is quitted. When the event is the other event, other processing (S1008) is performed, and processing is then quitted.

In the above processing steps, the application 1051 that is appropriate to the touch panel displays simple help related to the UI component of the touch position on the screen in response to a long press touch by the user. Furthermore, the full-contents help can be displayed when the hyperlink that is displayed in the simple help is tapped with another finger, and the screen of the application that is the invoker can be displayed when the full-contents help is closed.

### Second Embodiment

The first embodiment described an example in which the help application 211 was displayed on the full screen when the help application 211 was activated via the application 1051. In the second embodiment, an example will be described in which simultaneous display of both screens of the application 1051 and the help application 211 is enabled in an environment in the case where separate display of the screen of the monitor 1082 is enabled or two monitors are connected.

In order to simultaneously display both screens of the application 1051 and the help application 211, the simple help display unit 202 modifies the activation processing (S707) of the help application 211 of the touch process (S305). That is to say, when both the application 1051 and the help application 211 can be activated and displayed on the split screen depending on the size of the screen, the simple help display unit 202 commands the OS 1052 to activate and display the help application 211 on the split screen. Furthermore, when the simple help display unit 202 can activate and display the help application 211 on different screen from the screen on the application 1051 is displayed, the simple help display unit 202 commands the OS 1052 to activate and display the application 1051 on the different screen.

When both screens of the application 1051 and the help application 211 are simultaneously displayed, the help application 211 does not require the processing in the steps S1002, S1004 to S1006 in FIG. 10. Therefore, even in the absence of the processing in these steps, the screen of the application 1051 that is the invoker can be displayed when the help application 211 is closed.

In the above processing steps, the screen of the help application 211 can be displayed without hiding the screen of the application 1051, and therefore it is possible to return to the screen of the application 1051 when the help application 211 is closed.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2012-273501 filed Dec. 14, 2012, which is hereby incorporated by reference herein in its entirety.

What is claimed is:

1. An information processing apparatus comprising:
a display control unit configured to display help information related to a predetermined item upon receipt of an operation for a predetermined time period to the predetermined item that is displayed on a display screen of a display that includes a touch panel,
wherein when an operation is performed to an item that is different from the predetermined item after the help information related to the predetermined item is displayed, help information related to the different item is displayed on the screen without waiting for an operation for the predetermined time period to the different item.

2. The information processing apparatus according to claim 1, further comprising:
a storage unit configured to store the help information in association with each the item, and
a determination unit configured to determine whether the item to which the operation is performed has detailed help information, and
wherein, when it is determined that the item has the detailed help information, access information for accessing the detailed help information together with the acquired help information are displayed on the screen.

3. The information processing apparatus according to claim 2, wherein
the access information includes a link for accessing the detailed help information, and
when an operation to the link is received, the screen that displays the help information is hid, and the detailed help information is displayed as another screen.

4. The information processing apparatus according to claim 2, wherein
the access information includes a link for accessing the detailed help information, and
both a screen for displaying the help information and the item and a screen for displaying the detailed help information are simultaneously displayed on the one screen.

5. The information processing apparatus according to claim 1, wherein
the operation of the predetermined time period to the predetermined item is a touch operation for the predetermined time period on the predetermined item, and
the operation to the item that is different from the predetermined item is an operation in which the touch position is moved to the different item while the touch operation on the display is kept.

6. The information processing apparatus according to claim 1, wherein
the predetermined item is an item related to a print setting.

7. A method for controlling an information processing apparatus, comprising:
displaying help information related to a predetermined item upon receipt of an operation for a predetermined time period to the predetermined item that is displayed on a display screen that includes a touch panel, wherein when an operation is performed to an item that is different from the predetermined item after the help information related to the predetermined item is displayed, help information related to the different item is displayed on the screen without waiting for an operation for the predetermined time period to the different item.

8. The method according to claim 7, further comprising:
storing the help information in association with each the item, and
determining whether the item to which the operation is performed has detailed help information, and
wherein, when it is determined that the item has the detailed help information, access information for accessing the detailed help information together with the acquired help information are displayed on the screen.

9. The method according to claim 8, wherein
the access information includes a link for accessing the detailed help information, and
when an operation to the link is received, the screen that displays the help information is hid, and the detailed help information is displayed as another screen.

10. The method according to claim 8, wherein
the access information includes a link for accessing the detailed help information, and
both a screen for displaying the help information and the item and a screen for displaying the detailed help information are simultaneously displayed on the one screen.

11. The method according to claim 7, wherein the operation of the predetermined time period to the predetermined item is a touch operation for the predetermined time period on the predetermined item, and the operation to the item that is different from the predetermined item is an operation in which the touch position is moved to the different item while the touch operation on the display is kept.

12. The method according to claim 7, wherein
the predetermined item is an item related to a print setting.

13. A non-transitory storage medium on which is stored a computer program for making a computer execute a method for controlling an information processing apparatus, comprising:
displaying help information related to a predetermined item upon receipt of an operation for a predetermined time period to the predetermined item that is displayed on a display screen that includes a touch panel, wherein when an operation is performed to an item that is different from the predetermined item after the help information related to the predetermined item is displayed, help information related to the different item is displayed on the screen without waiting for an operation for the predetermined time period to the different item.

14. The non-transitory storage medium according to claim 13, further comprising:
storing the help information in association with each the item, and
determining whether the item to which the operation is performed has detailed help information, and
wherein, when it is determined that the item has the detailed help information, access information for accessing the detailed help information together with the acquired help information are displayed on the screen.

15. The non-transitory storage medium according to claim 14, wherein
the access information includes a link for accessing the detailed help information, and
when an operation to the link is received, the screen that displays the help information is hid, and the detailed help information is displayed as another screen.

16. The non-transitory storage medium according to claim 14, wherein
the access information includes a link for accessing the detailed help information, and
both a screen for displaying the help information and the item and a screen for displaying the detailed help information are simultaneously displayed on the one screen.

17. The non-transitory storage medium according to claim 13, wherein
the operation of the predetermined time period to the predetermined item is a touch operation for the predetermined time period on the predetermined item, and
the operation to the item that is different from the predetermined item is an operation in which the touch position is moved to the different item while the touch operation on the display is kept.

18. The non-transitory storage medium according to claim 13, wherein
the predetermined item is an item related to a print setting.
